(19) United States
(12) Patent Application Publication
(10) Pub. No.: US 2025/0256447 A1
(43) Pub. Date: Aug. 14, 2025

(54) CAST FILMS AND EXTRUSION-COATED SUBSTRATES CONTAINING NANOCOMPOSITE AND COMPATIBILIZER

(71) Applicant: Westlake Longview Corporation, Houston, TX (US)

(72) Inventors: Kranthi Chaitanya DANDA, Longview, TX (US); Darren Lavon SMITH, Kilgore, TX (US)

(73) Assignee: Westlake Longview Corporation, Houston, TX (US)

(21) Appl. No.: 19/050,749

(22) Filed: Feb. 11, 2025

Related U.S. Application Data
(60) Provisional application No. 63/552,305, filed on Feb. 12, 2024.

(51) Int. Cl. B29C 48/08; B29C 48/88; B29K 23/00; B29K 105/00; B29K 105/16; B32B 27/18; B32B 27/32; B32B 37/00; B32B 37/08; B32B 37/10; B32B 37/15

(52) U.S. Cl. CPC B29C 48/08; B29C 48/9145; B32B 27/18; B32B 27/32; B32B 37/0053; B32B 37/08; B32B 37/10; B32B 37/153; B29K 2023/0625; B29K 2023/086; B29K 2105/0067; B29K 2105/0085; B29K 2105/0088; B29K 2105/16; B32B 2250/02

(57) ABSTRACT

Disclosed are cast films and extrusion-coated substrates, and their methods of making. The cast films and coatings on the substrates are made from a composition containing an ungrafted ethylene-based polymer, a nanocomposite containing a polyamide and montmorillonite, and a compatibilizer comprising a maleic anhydride grafted ethylene-based polymer. These films and coatings can have improved optical and/or mechanical properties compared to films and coatings made without the nanocomposite.

### CROSS-REFERENCE TO RELATED APPLICATION/PRIORITY CLAIM

Priority of U.S. Provisional Patent Application No. 63/552,305 filed on Feb. 12, 2024, is hereby claimed; the entire content of which is hereby incorporated by reference.

### FIELD OF THE INVENTION

The invention generally relates to polymeric compositions useful for forming cast films, extrusion-coated substrates, and methods for making them.

### BACKGROUND OF THE INVENTION

Compatibilization of polar polymers, such as polyamide (PA) and/or ethylene-vinyl alcohol (EVOH) copolymer, with non-polar polymers, such as polyethylene (PE), is commonly carried out with maleic anhydride (MAH) grafted polymers. However, such multi-component compositions can produce films and coated substrates having less than desirable optical and/or mechanical properties.

There is a need in the art for cast films and extrusion-coated substrates containing compatibilized blends of PA and PE having improved optical and/or mechanical properties.

The present invention addresses this need as well as others, which will become apparent from the following description and the appended claims.

### SUMMARY OF THE INVENTION

The invention is as set forth in the appended claims.

Briefly, in one aspect, the present invention provides a cast film made from a composition comprising:
(a) an ungrafted ethylene-based polymer;
(b) a nanocomposite comprising a polyamide and montmorillonite; and
(c) a compatibilizer comprising a maleic anhydride grafted ethylene-based polymer.

In a second aspect, the present invention provides a method of making a cast film. The method comprises:
(a) extruding a polymeric melt through a flat die to form a sheet of polymer;
(b) passing the sheet on to a chill roll; and
(c) cooling the sheet to obtain the cast film,
wherein the polymeric melt comprises:
   (i) an ungrafted ethylene-based polymer;
   (ii) a nanocomposite comprising a polyamide and montmorillonite; and
   (iii) a compatibilizer comprising a maleic anhydride grafted ethylene-based polymer.

In a third aspect, the present invention provides an extrusion-coated substrate comprising:
(a) a film made from a composition comprising:
   (i) an ungrafted ethylene-based polymer;
   (ii) a nanocomposite comprising a polyamide and montmorillonite; and
   (iii) a compatibilizer comprising a maleic anhydride grafted ethylene-based polymer, and
(b) a flexible substrate coated with the film.

In a fourth aspect, the present invention provides a method of making an extrusion-coated substrate. The method comprises:
(a) extruding a polymeric melt through a flat die to form a sheet of polymer;
(b) contacting the sheet with a moving flexible substrate;
(c) pressing the sheet and the substrate together between a pressure roll and a chill roll; and
(d) cooling the pressed sheet and substrate to obtain the extrusion-coated substrate,
wherein the polymeric melt comprises:
   (i) an ungrafted ethylene-based polymer;
   (ii) a nanocomposite comprising a polyamide and montmorillonite; and
   (iii) a compatibilizer comprising a maleic anhydride grafted ethylene-based polymer.

### BRIEF DESCRIPTION OF THE DRAWINGS

FIGS. 1A-1C show optical microscopy images of the cast film formed from Example 2.

FIGS. 2A-2C show optical microscopy images of the cast film formed from Example 3.

FIGS. 3A-3C show optical microscopy images of the cast film formed from Example 4.

FIGS. 4A-4C show optical microscopy images of the cast film formed from Example 5.

FIGS. 5A-5C show optical microscopy images of the cast film formed from Example 9.

FIGS. 6A-6C show optical microscopy images of the cast film formed from Example 10.

FIGS. 7A-7C show optical microscopy images of the cast film formed from Example 11.

FIGS. 8A-8C show optical microscopy images of the cast film formed from Example 12.

### DETAILED DESCRIPTION OF THE INVENTION

It has been surprisingly discovered that cast films containing compatibilized blends of polar and non-polar polymers having improved optical and/or mechanical properties can be obtained by adding a nanocomposite comprising nylon and montmorillonite. The improved optical and/or mechanical properties include one or more of the following: higher clarity; higher gloss; lower haze; higher tensile strength; higher toughness; higher elongation; higher secant modulus; higher Elmendorf tear; fewer gels and unidentified agglomerates; and less immiscibility.

### Cast Film

Thus, in one aspect, the present invention provides a cast film made from a composition comprising:
(a) an ungrafted ethylene-based polymer;
(b) a nanocomposite comprising a polyamide and montmorillonite; and
(c) a compatibilizer comprising a maleic anhydride grafted ethylene-based polymer.

In various embodiments, the cast film is a flexible film.

The cast film may be single-layer or multilayer.

In various embodiments, the cast film is a single-layer cast film.

In various other embodiments, the cast film is a multilayer cast film.

In the case of a multilayer cast film, one or more layers may contain the ungrafted polyethylene, nanocomposite, and compatibilizer.

The cast film may have a thickness in the range of 5 to 250 μm, or 5 to 150 μm.

In various embodiments, the cast film is used for packaging.

### Composition

The composition used for making the cast film may contain from 1 to 99 wt %, from 10 to 99 wt %, from 20 to 99 wt %, from 30 to 99 wt %, from 40 to 99 wt %, from 50 to 99 wt %, from 55 to 99 wt %, from 60 to 99 wt %, from 65 to 99 wt %, from 70 to 99 wt %, from 75 to 99 wt %, from 80 to 99 wt %, from 85 to 99 wt %, from 90 to 99 wt %, from 93 to 99 wt %, from 95 to 99 wt %, or from 97 to 99 wt % of the ungrafted ethylene-based polymer, based on the weight of the composition.

The composition may contain from 0.1 to 40 wt %, from 0.1 to 35 wt %, 0.1 to 30 wt %, from 0.1 to 25 wt %, from 0.1 to 20 wt %, from 0.1 to 15 wt %, from 0.1 to 10 wt %, from 1 to 7 wt %, or from 3 to 5 wt % of the nanocomposite, based on the weight of the composition.

The composition may contain from 0.1 to 15 wt %, from 0.1 to 10 wt %, from 1 to 15 wt %, or from 1 to 10 wt % of the compatibilizer, based on the weight of the composition.

The composition may further comprise additional polar polymers, such as ethylene-vinyl alcohol (EVOH) copolymer or a non-composited polyamide.

In various embodiments, the composition further comprises EVOH copolymer.

In various other embodiments, the composition excludes EVOH copolymer.

If included, the composition may contain from 0.1 to 30 wt %, from 0.1 to 25 wt %, from 0.1 to 20 wt %, from 0.1 to 15 wt %, from 0.1 to 10 wt %, or from 0.1 to 5 wt % of the EVOH copolymer, based on the weight of the composition.

The EVOH copolymer may have an ethylene content ranging from 25 to 50 mol %, or from 27 to 44 mol % of ethylene, based on the total moles of the EVOH copolymer.

In various embodiments, the composition further comprises a non-composited polyamide.

If included, the composition may contain from 0.1 to 40 wt %, from 0.1 to 35 wt %, 0.1 to 30 wt %, from 0.1 to 25 wt %, from 0.1 to 20 wt %, from 0.1 to 15 wt %, from 0.1 to 10 wt %, or from 0.1 to 5 wt % of the non-composited polyamide, based on the weight of the composition.

In various embodiments, the ungrafted ethylene-based polymer, the non-composited polyamide, the EVOH copolymer, or combinations thereof may be sourced from post-industrial or post-consumer waste.

Post-industrial waste refers to manufacturing scrap, while post-consumer waste refers to waste produced by the end-user.

The composition may contain one or more conventional additives in typical amounts. Examples of the additives include heat stabilizers, antioxidants, lubricants, antistatic agents, dispersants, plasticizers, flame retardants, viscosity enhancers, ultraviolet light absorbers, light stabilizers, slip agents, anti-blocking agents, dyes, pigments, and fillers.

### Ethylene-Based Polymer

The terms “ethylene-based polymer” and “polyethylene” are used interchangeably herein. They refer to a polymer that contains more than 50 weight percent of polymerized ethylene monomer (based on the total amount of polymerizable monomers) and, optionally, may contain at least one comonomer. Ethylene-based polymer includes ethylene homopolymer and ethylene copolymers (meaning units derived from ethylene and one or more comonomers). Examples of ethylene-based polymer (polyethylene) include high-density polyethylene (HDPE), low-density polyethylene (LDPE), linear low-density polyethylene (LLDPE), very-low-density polyethylene (VLDPE), VLDPE with long branches, and ultra-low-density polyethylene (ULDPE) (also known as plastomers).

Generally, polyethylene may be produced in gas-phase, fluidized-bed reactors; liquid-phase, slurry process reactors; or liquid-phase, solution process reactors, using a heterogeneous catalyst system, such as Ziegler-Natta catalyst; a homogeneous catalyst system comprising Group 4 transition metals; and ligand structures, such as metallocene, non-metallocene metal-centered, heteroaryl, heterovalent aryloxyether, phosphine-imine, and others. Combinations of heterogeneous and/or homogeneous catalysts may also be used in either single-reactor or dual-reactor configurations.

In various embodiments, the ungrafted ethylene-based polymer includes HDPE, LDPE, LLDPE, VLDPE, ULDPE, or combinations thereof.

In various embodiments, the ungrafted ethylene-based polymer includes LLDPE.

In various embodiments, the ungrafted ethylene-based polymer has a melt index (I₂) of 0.1 to 50 g/10 minutes, of 0.1 to 40 g/10 minutes, of 0.1 to 30 g/10 minutes, of 0.1 to 20 g/10 minutes, of 0.1 to 15 g/10 minutes, of 0.1 to 10 g/10 minutes, or of 0.1 to 5 g/10 minutes (measured according to ASTM D1238 at Condition 190/2.16).

### Polyamide

The terms “amide-based polymer” and “polyamide” are used interchangeably. They refer to a polymer that contains more than 50 percent of amide bonds between monomers and, optionally, may contain at least one other bond type. Amide-based polymers include homopolymers and copolymers (meaning more than one kind of monomer used to form the amide-based polymer). Examples of amide-based polymers (polyamides) include aliphatic and semi-aromatic. Examples of aliphatic polyamides include polycaprolactam, poly(hexamethylene adipamide), poly(hexamethylene succinimide), polylaurolactam, poly(11-aminoundecanoic acid), and poly(hexamethylene sebacimide). Examples of semi-aromatic polyamides include poly(hexamethylene terephthalamide), poly(hexamethylene isophthalamide), and polymers utilizing both terephthalic acid and isophthalic acid along with an aliphatic diamine.

The polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

Amorphous polyamide refers to a polyamide having insufficient crystallinity, that is, not having an endothermic crystalline melting peak when measured by differential scanning calorimetry (DSC) (ASTM D-3417, 10° C./min).

In general, the polyamide can be prepared using diamine and dicarboxylic acid. Examples of the diamine include hexamethylenediamine, 2-methylpentamethylenediamine, 2,2,4-trimethylhexamethylenediamine, 2,4,4-trimethylhexamethylenedianiine, bis(4-aminocyclohexyl) methane, 2,2-bis(4-aminocyclohexyl) isopropylidene, 1,4-diaminocyclohexane, 1,3-diaminocyclohexane, meta-xylenediamine, 1, 5-diaminopentane, 1,4-diaminobutane, 1,3-diaminopropane, 2-ethyldiaminobutane, 1,4-diaminomethylcyclohexane, methane-xylenediamine, alkyl-substituted or unsubstituted m-phenylenediamine and p-phenylenediamine, etc. Examples of the dicarboxylic acid include alkyl-substituted or unsubstituted isophthalic acid, terephthalic acid, adipic acid, sebacic acid, butanedicarboxylic acid, etc.

Polyamide prepared using an aliphatic diamine and an aliphatic dicarboxylic acid is generally semicrystalline polyamide. The semicrystalline polyamide is generally prepared using lactam, such as nylon 6 or nylon 11, or an amino acid, but may also be prepared by condensing a diamine, such as hexamethylenediamine, with a dibasic acid, such as succinic acid, adipic acid, or sebacic acid. The polyamide may be a copolymer or a terpolymer such as a copolymer of hexamethylenediamine/adipic acid and caprolactam (nylon 6,66). A mixture of two or more semicrystalline polyamides can also be used.

Amorphous polyamide is typically obtained when either diamine or dicarboxylic acid is aromatic, and the other is aliphatic. Examples of aliphatic groups of the amorphous polyamide include C₁-C₁₅ aliphatic or C₄-C₈ alicyclic alkyls. Examples of aromatic groups of the amorphous polyamide include substituted C₁-C₆ mono- or bicyclic aromatic groups.

Examples of amorphous polyamides include hexamethylenediamine isophthalamide, a mixture of 2,2,4- and 2,4,4-trimethylhexamethylenediamine terephthalamide, a copolymer of hexamethylenediamine or 2-methylpentamethylenediamine and an isophthalic acid, terephthalic acid, or mixtures thereof.

The semicrystalline and amorphous polyamides may be prepared by condensation polymerization, as well-known in the art.

In various embodiments, the polyamide includes nylon 4.6, nylon 6, nylon 6.6, nylon 6.10, nylon 6.12, nylon 11, nylon 12, amorphous nylon, or combinations thereof.

In various embodiments, the polyamide includes nylon 6.

### Montmorillonite

The other component of the nanocomposite is montmorillonite. Montmorillonite is a very soft phyllosilicate group of minerals that form when they precipitate from water solution as microscopic crystals, known as clay. Montmorillonite is a 2:1 clay, meaning that it has two tetrahedral sheets of silica sandwiching a central octahedral sheet of alumina. The particles are plate-shaped with average dimension of 1 nm thick and 70-150 nm wide. Chemically, it is hydrated sodium calcium aluminium magnesium silicate hydroxide (Na,Ca)_{0.33}(Al,Mg)₂(Si₄O₁₀)(OH)₂·nH₂O. Potassium, iron, and other cations are common substitutes, and the exact ratio of cations varies with the source.

The clay may or may not be modified with organic compounds having polar or ionic pendants, such as quaternary ammonium, phosphonium, maleate, succinate, acrylate, benzylic hydrogen, and oxazoline. If used, the content of the organic material may range from 1 to 45 wt %, based on the weight of the clay.

The clay layers can have a thickness of 1 to 100 nm and a length of 20 to 1000 nm. The clay's unit cell charge may vary from 0.3 to 0.8. The surface area of this material may vary from 400 to 1000 m²/g.

### Nanocomposite

The clay may be incorporated into the polyamide to form the nanocomposite using any suitable method, such as solid-melt blending, suspension-liquid feeding, solution-liquid feeding, or may be added during synthesis of the polyamide. The preferred method of incorporation is addition during synthesis of the polyamide.

The nanocomposite may contain from 1 to 20 wt %, or from 2 to 8 wt % of montmorillonite, based on the weight of the nanocomposite.

The nanocomposite may contain from 80 to 99 wt %, or from 92 to 98 wt % of polyamide, based on the weight of the nanocomposite.

### Compatibilizer

A compatibilizer is typically used to improve the compatibility of a non-polar polymer, such as a polyolefin, with a polar polymer, such as polyamide and ethylene-vinyl alcohol (EVOH) copolymer.

Examples of compatibilizers include an epoxy-modified polystyrene copolymer, an ethylene-(meth) acrylate copolymer, an ethylene-alkyl (meth)acrylate copolymer (such as ethylene-methyl acrylate copolymer (block or random) and ethylene-butyl acrylate copolymer (block or random)), an ethylene-vinyl acetate copolymer, and combinations thereof.

Additional examples of compatibilizers include anhydride and/or carboxylic acid functionalized ethylene-based polymers. Examples of anhydride and/or carboxylic acid functional groups include acrylic acid, methacrylic acid, maleic acid, fumaric acid, itaconic acid, citraconic acid, maleic anhydride, tetrahydrophthalic anhydride, norborn-5-ene-2,3-dicarboxylic acid anhydride, nadic anhydride, and himic anhydride. Maleic anhydride is preferred.

In various embodiments, the compatibilizer comprises a maleic anhydride grafted ethylene-based polymer.

Examples of maleic anhydride grafted ethylene-based polymers include maleic anhydride grafted HPDE, maleic anhydride grafted LPDE, maleic anhydride grafted LLPDE, maleic anhydride grafted VLPDE, maleic anhydride grafted ULDPE, maleic anhydride grafted ethylene-(meth)acrylate copolymer, maleic anhydride grafted ethylene-alkyl (meth)acrylate copolymer (such as maleic anhydride grafted ethylene-methyl acrylate copolymer (block or random) and maleic anhydride grafted ethylene-butyl acrylate copolymer (block or random)), maleic anhydride grafted ethylene-vinyl acetate copolymer, or combinations thereof.

In various embodiments, the compatibilizer comprises a maleic anhydride grafted ethylene-hexene copolymer.

In various embodiments, the maleic anhydride grafted ethylene-hexene copolymer has a density of 0.905 to 0.910 g/cm³.

In various embodiments, the compatibilizer comprises a maleic anhydride grafted ULDPE.

In various embodiments, the maleic anhydride grafted ULDPE has a density of less than 0.880 g/cm³.

In various embodiments, the compatibilizer comprises a maleic anhydride grafted ethylene-methyl acrylate copolymer.

In various embodiments, the maleic anhydride grafted ethylene-methyl acrylate copolymer comprises from 15 to 25 wt % of methyl acrylate, based on the weight of the ethylene-methyl acrylate copolymer.

In various embodiments, the compatibilizer comprises a maleic anhydride grafted ethylene-butyl acrylate copolymer.

In various embodiments, the maleic anhydride grafted ethylene-butyl acrylate copolymer comprises from 18 to 24 wt % of butyl acrylate, based on the weight of the ethylene-butyl acrylate copolymer.

The functionalized ethylene-based polymer may contain from 0.1 to 3.0 wt %, from 0.5 to 2.5 wt %, from 0.5 to 2.0 wt %, or from 1.0 to 2.0 wt % of the anhydride and/or carboxylic acid functional group, based on the weight of the functionalized ethylene-based polymer.

In various embodiments, the compatibilizer has a melt index of 0.5 to 1,500 g/10 min, of 0.5 to 1,000 g/10 min, of 0.5 to 750 g/10 min, of 0.5 to 500 g/10 min, of 0.5 to 250 g/10 min, of 0.5 to 100 g/10 min, of 0.5 to 50 g/10 min, of 0.5 to 40 g/10 min, of 0.5 to 30 g/10 min, of 0.5 to 20 g/10 min, of 0.5 to 15 g/10 min, or of 0.5 to 10 g/10 min (measured according to ASTM D1238 at Condition 190/2.16).

In various embodiments, the compatibilizer has a melt index of 30 to 1,500 g/10 min, of 30 to 1,000 g/10 min, of 30 to 750 g/10 min, of 30 to 500 g/10 min, of 30 to 250 g/10 min, or of 30 to 100 g/10 min (measured according to ASTM D1238 at Condition 190/2.16).

In various embodiments, the compatibilizer has a melt index of 100 to 1,500 g/10 min, of 100 to 1,000 g/10 min, of 100 to 750 g/10 min, of 100 to 500 g/10 min, or of 100 to 250 g/10 min (measured according to ASTM D1238 at Condition 190/2.16).

In various embodiments, the compatibilizer has a melt index of 250 to 1,500 g/10 min, of 250 to 1,000 g/10 min, of 250 to 750 g/10 min, or of 250 to 500 g/10 min (measured according to ASTM D1238 at Condition 190/2.16).

### Method of Making Cast Film

In a second aspect, the invention provides a method of making a cast film. The method comprises:
(a) extruding a polymeric melt through a flat die to form a sheet of polymer;
(b) passing the sheet on to a chill roll; and
(c) cooling the sheet to obtain the cast film, wherein the polymeric melt comprises:
   (i) an ungrafted ethylene-based polymer;
   (ii) a nanocomposite comprising a polyamide and montmorillonite; and
   (iii) a compatibilizer comprising a maleic anhydride grafted ethylene-based polymer.

The ungrafted ethylene-based polymer, nanocomposite, and compatibilizer are as described above.

The polymeric melt may be prepared by melt blending the ingredients by any suitable method, such as by single-screw extrusion, co- or counter-rotating twin-screw extrusion, batch mixers, and any combination thereof. The ingredients may be introduced in the form of pellet, shred, grind, regrind, fluff, scrap, or any combination thereof.

In various embodiments, the polymeric melt may be prepared by first passing a film or films (containing one or more of the ingredients) through film shredding equipment, such as an Erema plastic recycling system. One or more ingredients of the polymer melt may enter the recycling system in film form and may exit in pellet form, grind form, fluff form, or any combination thereof.

The film(s) introduced into the plastic recycling system may be virgin, post-consumer recycled (PCR), post-industrial recycled (PIR), or any combination thereof.

The recycled film(s) (e.g., in pellet form, grind form, fluff form, or any combination thereof) may then be used to prepare the polymeric melt as described above.

The polymeric melt may be derived from a concentrate/masterbatch or a fully formulated/compounded formulation.

The terms “masterbatch” and “concentrate” are used interchangeably. They refer to a mixture that has a higher concentration of any component (e.g., the nanocomposite and/or the compatibilizer) than a fully compounded or a fully formulated composition. The masterbatch can include a carrier resin. One or more of the ungrafted ethylene-based polymers may be used as the carrier resin. The masterbatch is typically diluted with a letdown resin to form the fully formulated composition. One or more of the ungrafted ethylene-based polymers may be used as the letdown resin. The letdown resin may be the same or different polymer than the carrier resin. The masterbatch can be formed by dry mixing and/or melt blending the components. A fully formulated composition is what is ultimately used to form the cast film.

In the extrusion step, resin pellets (or other suitable forms of the ingredients) are typically gravity fed into a heated barrel of an extruder. The pellets are conveyed down the barrel by a screw that first compacts and then melts the pellets through shear-induced heat. The last section of the screw, also known as the metering section, ensures a homogeneous melt and uniform output.

Next, the polymer melt is extruded through a flat sheet extrusion die (often referred to as a “flat die”). The flat die may have various designs, such as “keyhole,” “T-shaped,” or “coat hanger.” The molten sheet of polymer (cast film) is usually extruded downward, but in some cases, can be extruded horizontally. Within inches after exiting the die, the sheet is deposited onto a rotating chilled roller where the melt is cooled and solidified. An air knife can be used in conjunction with the chill roller to expedite cooling. The chill roller can be polished smooth, have a matte finish, or be embossed with a repeating pattern. Following quenching, the film can traverse a nip roll before being wound at a winding station. Film edges are usually trimmed, chopped, and re-introduced into the system as flaky material called “fluff” or “regrind.” The film thickness can be reduced at the nip roll. Thickness can also be controlled by altering the winder speed and the nip tension. The film can be subjected to lateral draw with the use of drawing pins to a desired final film thickness. Film thicknesses can range, for example, in the range of 5 to 250 μm, or from 10 to 125 μm.

### Extrusion-Coated Substrate

The inventive cast film is particularly suitable to be applied onto a flexible substrate to form an extrusion-coated substrate.

Thus, in a third aspect, the present invention provides an extrusion-coated substrate comprising:
(a) a film made from a composition comprising:
   (i) an ungrafted ethylene-based polymer;
   (ii) a nanocomposite comprising a polyamide and montmorillonite; and
   (iii) a compatibilizer comprising a maleic anhydride grafted ethylene-based polymer, and
(b) a flexible substrate coated with the film.

The film of the extrusion-coated substrate may be characterized by any and all of the features of the cast film described herein. Likewise, the ungrafted ethylene-based polymer, nanocomposite, and compatibilizer are as described above.

The flexible substrate may be any known in the art suitable for extrusion coating. Examples of flexible substrates include paper, paperboard, metal foil, nonwoven fabric, plastic film, and combinations thereof. Examples of paper and paperboard include Kraft and glassine. An example of metal foil includes aluminum. Examples of plastic films include polyethylene, polypropylene, polyamide, polyester, polyvinyl chloride (PVC), polyvinylidene chloride (PVDC), and polyacrylonitrile (PAN). These plastic films may be oriented or unoriented, metallized or unmetallized, treated or untreated by physical or chemical means, and coated or uncoated with a thin inorganic barrier layer.

### Method of Making Extrusion-Coated Substrate

In a fourth aspect, the present invention provides a method of making an extrusion-coated substrate. The method comprises:
(a) extruding a polymeric melt through a flat die to form a sheet of polymer;
(b) contacting the sheet with a moving flexible substrate;
(c) pressing the sheet and the substrate together between a pressure roll and a chill roll; and
(d) cooling the pressed sheet and substrate to obtain the extrusion-coated substrate,
wherein the polymeric melt comprises:
   (i) an ungrafted ethylene-based polymer;
   (ii) a nanocomposite comprising a polyamide and montmorillonite; and
   (iii) a compatibilizer comprising a maleic anhydride grafted ethylene-based polymer.

The polymer melt, its components, and the flexible substrate are as described above.

In the extrusion step, resin pellets (or other suitable forms of the ingredients) are typically gravity fed into a heated barrel of an extruder. The pellets are conveyed down the barrel by a screw that first compacts and then melts the pellets through shear-induced heat. The last section of the screw, also known as the metering section, ensures a homogeneous melt and uniform output.

Next, the polymer melt is extruded through a flat sheet extrusion die (often referred to as a “flat die”). The flat die may have various designs, such as “keyhole,” “T-shaped,” or “coat hanger.” The molten sheet of polymer is usually drawn down from the die into the nip between two rolls (a chill roll and a pressure roll) below the die. Here, as the molten sheet comes into contact with a faster moving substrate on the pressure roll, the hot sheet is drawn out to the desired thickness, or gauge. The hot sheet is then forced onto the substrate as both layers are pressed together between the two rolls.

The combination of the pressed sheet and the substrate is then rapidly cooled by the chill roll to form an extrusion-coated substrate.

### General Provisions

To remove any doubt, the present invention includes and expressly contemplates and discloses any and all combinations of embodiments, features, characteristics, parameters, and/or ranges mentioned herein. That is, the subject matter of the present invention may be defined by any combination of embodiments, features, characteristics, parameters, and/or ranges mentioned herein.

It is contemplated that any ingredient, component, or step that is not specifically named or identified as part of the present invention may be explicitly excluded.

Any process/method, apparatus, compound, composition, embodiment, or component of the present invention may be modified by the transitional terms “comprising,” “consisting essentially of,” or “consisting of,” or variations of those terms.

As used herein, the indefinite articles “a” and “an” mean one or more, unless the context clearly suggests otherwise. Similarly, the singular form of nouns includes their plural form, and vice versa, unless the context clearly suggests otherwise.

While attempts have been made to be precise, the numerical values and ranges described herein may be considered approximations. These values and ranges may vary from their stated numbers depending upon the desired properties sought to be obtained by the present disclosure as well as the variations resulting from the standard deviation found in the measuring techniques. Moreover, the ranges described herein are intended and specifically contemplated to include all sub-ranges and values within the stated ranges. For example, a range of 50 to 100 is intended to include all values within the range including sub-ranges such as 60 to 90, 70 to 80, etc.

Any two numbers of the same property or parameter reported in the working examples may define a range. Those numbers may be rounded off to the nearest thousandth, hundredth, tenth, whole number, ten, hundred, or thousand to define the range.

The content of all documents cited herein, including patents as well as non-patent literature, is hereby incorporated by reference in their entirety. To the extent that any incorporated subject matter contradicts with any disclosure herein, the disclosure herein shall take precedence over the incorporated content.

This invention can be further illustrated by the following working examples, although these examples are included merely for purposes of illustration and are not intended to limit the scope of the invention.

### EXAMPLES

### Analytical Methods

Gloss at 45° was measured according to ASTM D-2457.

Haze was measured according to ASTM D-1003.

Tensile strength, tensile toughness, elongation, and secant modulus were measured according to ASTM D-882.

Puncture resistance was measured according to ASTM D-5748.

Dart impact strength was measured according to ASTM D-1709 method A.

Elmendorf tear was measured according to ASTM D-1922.

Film clarity was measured according to ASTM D-1746-15.

### Example 1—Control

### Preparation of Polyethylene (PE) Film Containing Nylon but No Compatibilizer

70% (wt./wt.) of a linear low-density polyethylene (Westlake Chemical HIFOR® LF2020AA having a melt index of 1.0 g/10 min. and density of 0.919 g/cm³) and 30% (wt./wt.) of a polyamide 6 without nanoparticles (Domo Chemical Domamide H40 F) were added in pellet form to a twin-screw extruder and melt blended to form a concentrate. The extrusion barrel temperature set point was 170° C. in zone 1, 200° C. in zone 2, 205° C. in zone 3, 245° C. in zone 4, 250° C. in zone 5 through zone 10, 240° C. in zone 11, 220° C. in zone 12, and 215° C. at the die. The screw speed was 275 RPM (revolutions per minute) with a 25 SCFH (Standard Cubic Foot per Hour) nitrogen purge rate, and a total output of 12.0 pounds per hour. The melt blend concentrate was pelletized for further processing.

35% (wt./wt.) of the resulting concentrate pellets and 65% (wt./wt.) of a linear low-density polyethylene resin (Westlake Chemical HIFOR® LT74104 having a melt index of 1.0 g/10 min. and density of 0.920 g/cm³) were added to the feed of a monolayer casting film line as a pellet blend and formed into a monolayer cast film. The extrusion barrel temperature set point was 163° C. in zone 1, 185° C. in zone 2, 204° C. in zone 3, 220° C. in the adapter zone, and 235° C. in the die zone. The screw speed was set at 90 RPM. The melt pressure was between 2,600 and 3,200 psi. The target melt temperature was set between 235° C. and 238° C. The winder line speed was set at 5 m/min, the nip tension was set at 7 Nm, and the winder tension was set at 6 Nm. Film width was targeted at 4.5-5.0 inches using a 6-inch sheet die, and film thickness was 5 mils. The chill-roll temperature was set at 20° C. The output of the process was 6 lbs/hr.

This film was then subjected to testing for packing film properties. The results are reported in Table 1 below.

### Example 2—Inventive

### Preparation of PE Film Containing Nanocomposite and Compatibilizer (RETAIN®)

Pellets of a concentrate containing 65% (wt./wt.) of a linear low-density polyethylene (Westlake Chemical HIFOR® LF2020AA having a melt index of 1.0 g/10 min. and density of 0.919 g/cm³), 30% (wt./wt.) of a polyamide 6 nanocomposite (Domo Chemical 1300 IF 102.3), and 5% (wt./wt.) of a maleated polyethylene copolymer compatibilizer (Dow RETAIN® 3000 having a melt index of 660 g/10 min. and density of 0.870 g/cm³ and containing 1.4 wt % grafted maleic anhydride) were prepared using the procedure and conditions of Example 1.

35% (wt./wt.) of the resulting concentrate pellets and 65% (wt./wt.) of a linear low-density polyethylene resin (Westlake Chemical HIFOR® LT74104 having a melt index of 1.0 g/10 min. and density of 0.920 g/cm³) were added to the feed of a monolayer casting film line as a pellet blend and formed into a monolayer cast film using the procedure and conditions of Example 1, except film thickness was from 3 to 3.5 mils.

This film was then subjected to testing for packing film properties. The results are reported in Table 1 below.

### Example 3—Comparative

### Preparation of PE Film Containing Nylon and Compatibilizer (RETAIN®)

Pellets of a concentrate containing 65% (wt./wt.) of a linear low-density polyethylene (HIFOR® LF2020AA), 30% (wt./wt.) of a polyamide 6 without nanoparticles (Domo Chemical Domamide H40 F), and 5% (wt./wt.) of a maleated polyethylene copolymer compatibilizer (Dow RETAIN® 3000) were prepared using the procedure and conditions of Example 1.

35% (wt./wt.) of the resulting concentrate pellets and 65% (wt./wt.) of a linear low-density polyethylene resin (HIFOR® LT74104) were pellet blended and formed into a monolayer cast film using the procedure and conditions of Example 1, except film thickness was from 3 to 3.5 mils.

This film was then subjected to testing for packing film properties. The results are reported in Table 1 below.

### Example 4—Inventive

### Preparation of PE Film Containing Nanocomposite and Compatibilizer (Mal-EMAC®)

Pellets of a concentrate containing 65% (wt./wt.) of a linear low-density polyethylene (HIFOR® LF2020AA), 30% (wt./wt.) of a polyamide 6 nanocomposite (Domo Chemical 1300 IF 102.3), and 5% (wt./wt.) of a maleated ethylene-methyl acrylate copolymer compatibilizer (melt index of 10 g/10 min., 24 wt % of methyl acrylate, and 1.4 wt % of grafted maleic anhydride) were prepared using the procedure and conditions of Example 1.

35% (wt./wt.) of the resulting concentrate pellets and 65% (wt./wt.) of a linear low-density polyethylene resin (HIFOR® LT74104) were pellet blended and formed into a monolayer cast film using the procedure and conditions of Example 1, except film thickness was from 3 to 3.5 mils.

This film was then subjected to testing for packing film properties. The results are reported in Table 1 below.

### Example 5—Comparative

### Preparation of PE Film Containing Nylon and Compatibilizer (Mal-EMAC®)

Pellets of a concentrate containing 65% (wt./wt.) of a linear low-density polyethylene (HIFOR® LF2020AA), 30% (wt./wt.) of a polyamide 6 without nanoparticles (Domo Chemical Domamide H40 F), and 5% (wt./wt.) of a maleated ethylene-methyl acrylate copolymer compatibilizer (melt index of 10 g/10 min., 24 wt % of methyl acrylate, and 1.4 wt % of grafted maleic anhydride) were prepared using the procedure and conditions of Example 1.

35% (wt./wt.) of the resulting concentrate pellets and 65% (wt./wt.) of a linear low-density polyethylene resin (HIFOR® LT74104) were pellet blended and formed into a monolayer cast film using the procedure and conditions of Example 1, except film thickness was from 3 to 3.5 mils.

This film was then subjected to testing for packing film properties. The results are reported in Table 1 below.

TABLE 1

| | Ex. 1 | Ex. 2 | Ex. 3 | Ex. 4 | Ex. 5 |
|---|---|---|---|---|---|
| Concentrate | | | | | |
| Comp. | | | | | |
| (wt %) | | | | | |
| LLDPE | 70 | 65 | 65 | 65 | 65 |
| PA 6 | 30 | — | 30 | — | 30 |
| PA 6 | — | 30 | — | 30 | — |
| Nano- | | | | | |
| composite | | | | | |
| mal-PE | — | 5 | 5 | — | — |
| mal- | — | — | — | 5 | 5 |
| EMAC ® | | | | | |
| Film Comp. | | | | | |
| (wt. %) | | | | | |
| Concentrate | 35 | 35 | 35 | 35 | 35 |
| LLDPE | 65 | 65 | 65 | 65 | 65 |
| Film | 5.0 | 3.4 | 3.4 | 3.5 | 3.5 |
| Thickness | | | | | |
| (mil) | | | | | |
| Optical | | | | | |
| Properties | | | | | |
| Clarity (%) | 36.3 | 88.5 | 18.3 | 77.7 | 21.6 |
| Gloss at 45° | 11.8 | 23 | 7.3 | 11.8 | 6.8 |
| Haze (%) | 45.1 | 11 | 73 | 11.3 | 69 |
| Tensile | | | | | |
| Strength | | | | | |
| (psi) | | | | | |
| At Break | 1429 | 6019 | 3500 | 6043 | 3534 |
| MD | | | | | |
| At Yield | 710 | 1715 | 1510 | 1546 | 1358 |
| MD | | | | | |
| Tensile | | | | | |
| Toughness | | | | | |
| (ft-lbs/in³) | | | | | |
| MD | 442 | 2666 | 1318 | 2818 | 1121 |
| Elongation | | | | | |
| (%) | | | | | |
| MD | 526 | 989 | 720 | 1047 | 666 |
| Secant | | | | | |
| Modulus | | | | | |
| (psi) | | | | | |
| MD | 17,400 | 29,100 | 24,200 | 34,200 | 22,700 |
| Puncture | | | | | |
| Resistance | | | | | |
| Force per | 2.14 | * | 4.99 | 5.07 | 5.75 |
| mil (lbs/mil) | | | | | |
| Load at | 10.70 | * | 15.46 | 16.22 | 18.98 |
| Break (lbs) | | | | | |
| Energy to | 4.86 | * | 2.77 | 6.20 | 3.98 |
| Break | | | | | |
| (in-lbs) | | | | | |
| Penetration | 2.60 | * | 2.85 | 3.22 | 2.99 |
| (inches) | | | | | |
| Elmendorf | | | | | |
| Tear (g) | | | | | |
| MD | 1053 | 1057 | 925 | 838 | 1115 |

* = Omitted due to testing error.

As seen in Table 1, the film containing the nylon nanocomposite and the RETAIN® compatibilizer (Example 2) had better optical (e.g., clarity, gloss, and/or haze) and mechanical properties (e.g., tensile strength, tensile toughness, elongation, Secant modulus, and/or Elmendorf tear) than the Control (Example 1) and the corresponding film without the nylon nanocomposite (Example 3). Similarly, the film containing the nylon nanocomposite and the mal-EMAC® compatibilizer (Example 4) had better optical (e.g., clarity, gloss, and/or haze) and mechanical properties (e.g., tensile strength, tensile toughness, elongation, Secant modulus, and/or Elmendorf tear) than the Control (Example 1) and the corresponding film without the nylon nanocomposite (Example 5).

Additionally, in certain instances, the cast films containing the mal-EMAC® compatibilizer unexpectedly had better mechanical properties than the corresponding films with the RETAIN® compatibilizer.

### Optical Microscopy Analysis

The film from Example 1 was too poor in quality to warrant optical microscopy analysis. Its defects were apparent to the naked eye.

The films from Examples 2-5 were analyzed by optical microscopy.

The films were cut and placed between precleaned microslides made of Swiss glass with dimensions 25×75×1 mm. A Keyence VHX-2000E optical microscope with a VH-Z100R/W/T lens was employed for imaging. Software interface was VHX-2000 version 2.3.5.1. The permissible magnification for this lens was 100-1000×. The micrographs were captured at 100×, 200×, and 500× magnification in reflectance mode.

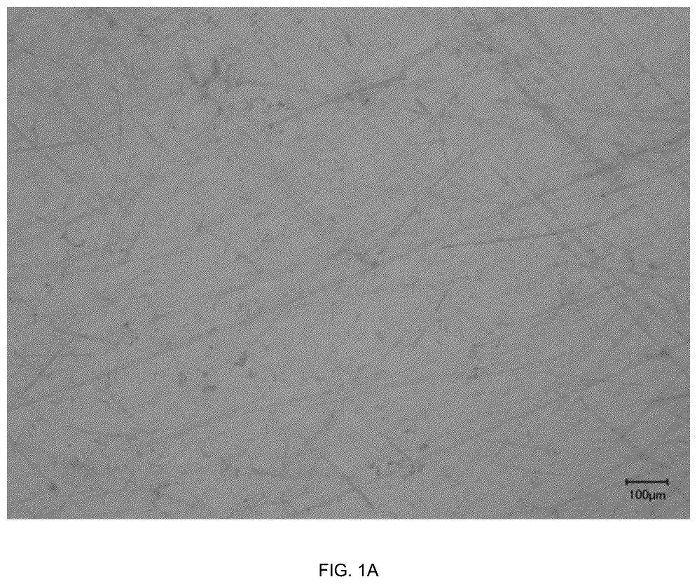

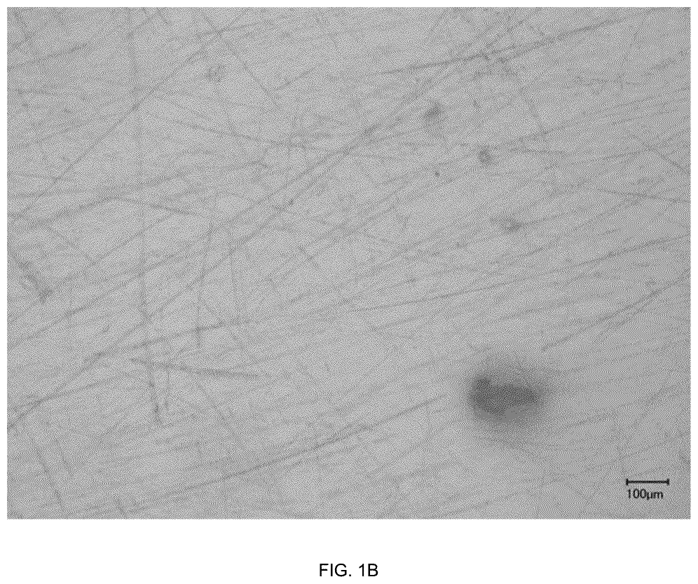

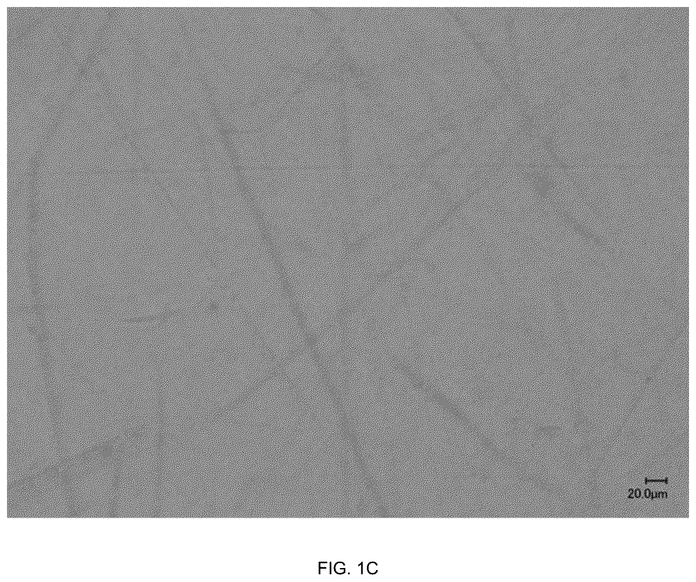

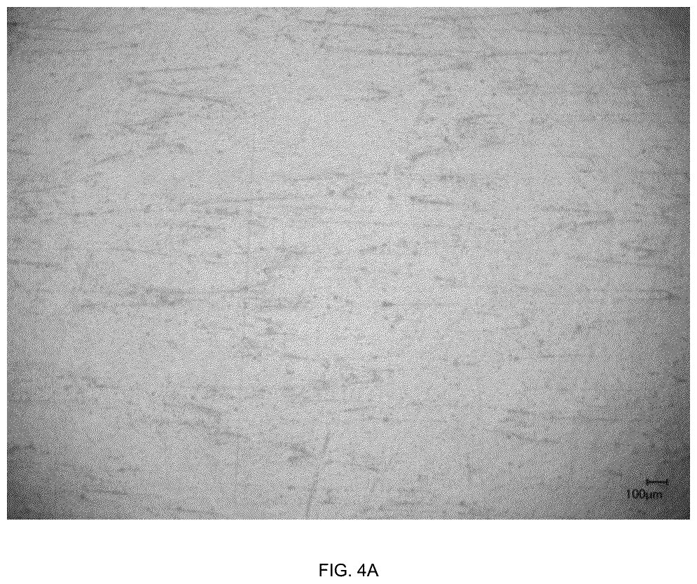

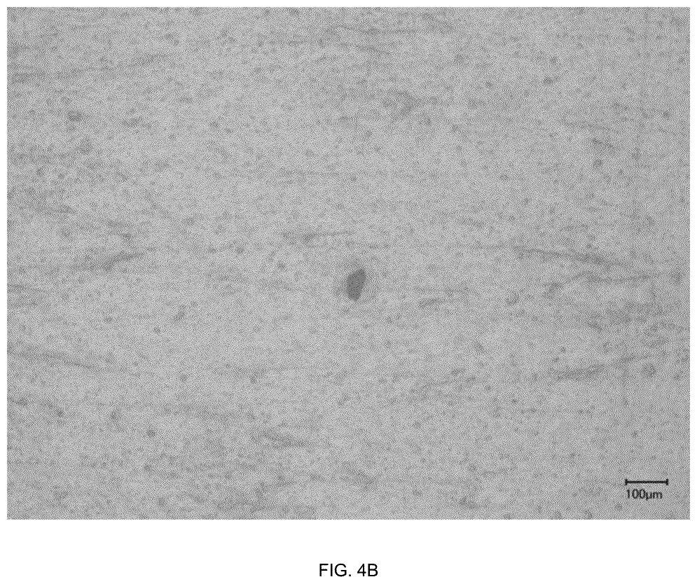

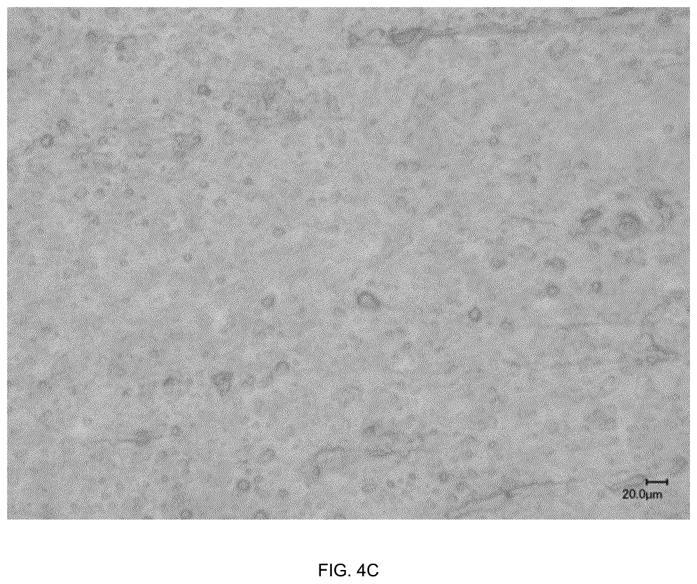

Three representative micrographs are shown for each composition in FIGS. 1-4, respectively. FIGS. 1C, 20, 3C, and 4C were captured at a magnification of 500×. FIG. 4A was captured at a magnification of 100×. All other figures were captured at a magnification of 200×.

For each composition, micrograph labeled (A) is representative of voids, micrograph (B) is representative of gels, and micrograph labeled (C) is representative of immiscibility within the film.

Voids could be a physical opening in the film. Gels could be globs of likely dissimilar material thicker than surrounding film. Gels pose an obstruction to normal deformation by acting as stress concentration points. Immiscibility could be observed as surface roughness or inhomogeneity.

As seen in FIGS. 1A-1C (nanocomposite and RETAIN® compatibilizer (Example 2)), the microscopic images show several small gels and big unidentified agglomerates. Miscibility was high as the micrographs do not display any immiscible phases.

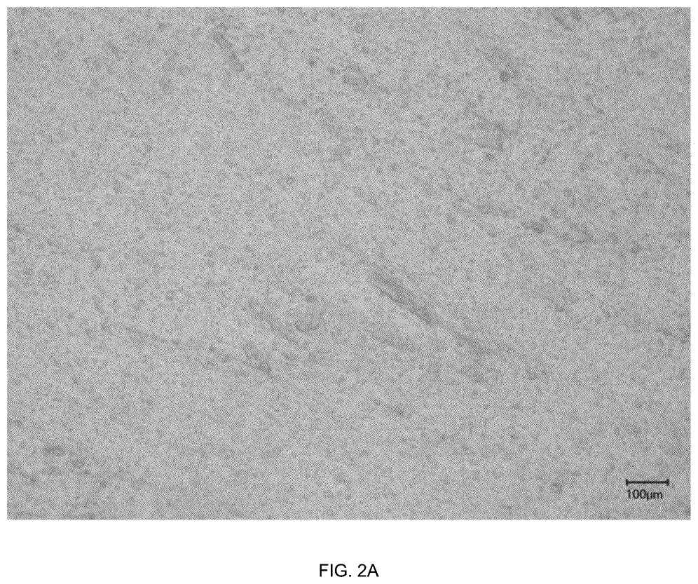

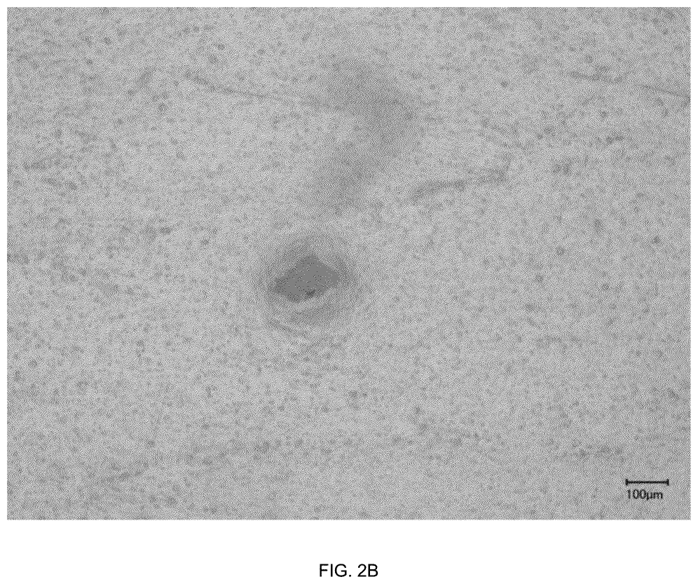

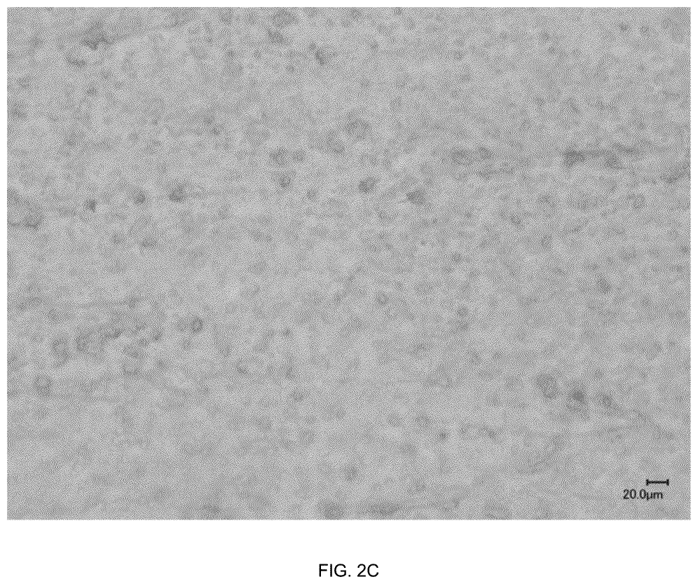

As seen in FIGS. 2A-2C (nylon and RETAIN® compatibilizer (Example 3)), the microscopic images show several big gels, big unidentified agglomerates, and a lot of immiscibility.

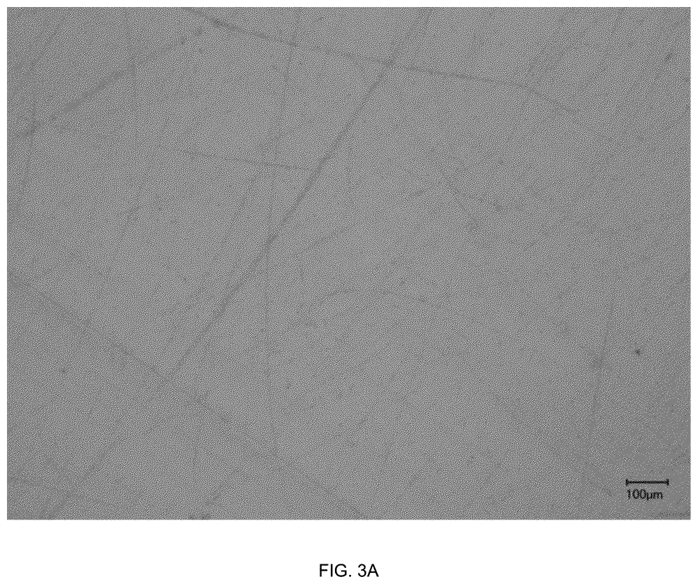

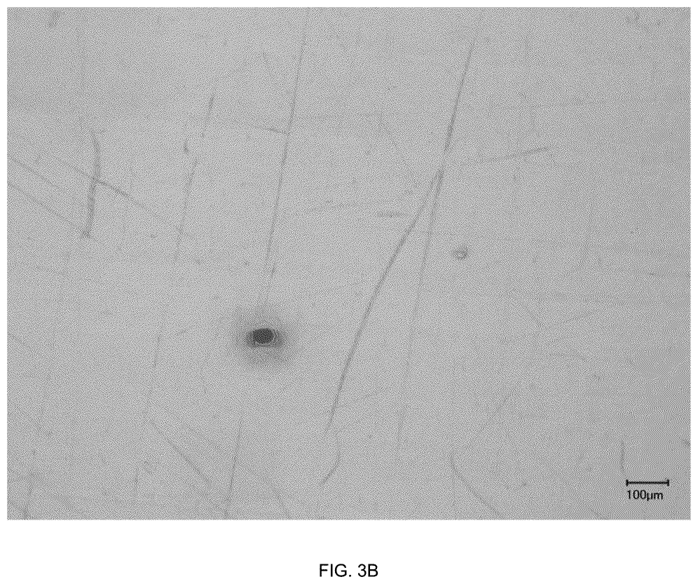

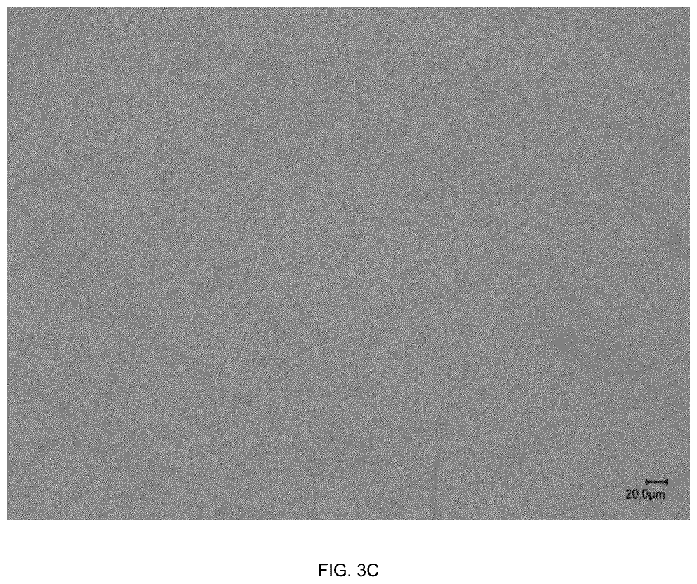

As seen in FIGS. 3A-3C (nanocomposite and mal-EMAC® compatibilizer (Example 4)), the microscopic images show no gels or immiscible phases, and an insignificant presence of small unidentified agglomerates.

As seen in FIGS. 4A-4C (nylon and mal-EMAC® compatibilizer (Example 5)), the microscopic images show several big gels, small unidentified agglomerates, and a lot of immiscibility. Additionally, as seen in FIG. 4A, droplet break-up phenomena were observed when the gels of the minor phase were stretched in the draw direction (Ramic, A. J., et. al., Polymer 41 (2000) 6263-6270). The presence of the compatibilizer aided in providing an enhanced interface. In contrast, no such phenomena were observed with nylon and RETAIN® compatibilizer (Example 3 and FIGS. 2A-2C).

Of the four, the film with the nanocomposite and the mal-EMAC® compatibilizer (Example 4) showed the best microscopic appearance.

As a final note, the surface of some of the film samples is believed to have been scratched during manufacturing, handling, and/or storage, prior to being prepped for microscopy. The extrusion equipment did not add skin layers onto the produced films. This omission is believed to have led to the lines seen in some micrographs. The lines are believed to be an artifact of the cast-film process, rather than an outcome of the composition or interactions of the composition components.

### Example 6—Comparative

### Preparation of PE Film Containing Nylon and Compatibilizer (Mal-PE)

Pellets of a concentrate containing 65% (wt./wt.) of a linear low-density polyethylene (HIFOR® LF2020AA), 30% (wt./wt.) of a polyamide 6 without nanoparticles (Domo Chemical Domamide H40 F), and 5% (wt./wt.) of a maleated polyethylene (melt index of 8 g/10 min. and 1.4 wt. % of grafted maleic anhydride) were prepared using the procedure and conditions of Example 1.

35% (wt./wt.) of the resulting concentrate pellets and 65% (wt./wt.) of a linear low-density polyethylene resin (HIFOR® LT74104) were pellet blended and formed into a monolayer cast film using the procedure and conditions of Example 1, except film thickness was from 3 to 3.5 mils.

This film was then subjected to testing for packing film properties. The results are reported in Table 2 below.

### Example 7—Inventive

### Preparation of PE Film Containing Nanocomposite and Compatibilizer (Mal-PE)

Pellets of a concentrate containing 65% (wt./wt.) of a linear low-density polyethylene (HIFOR® LF2020AA), 30% (wt./wt.) of a polyamide 6 nanocomposite (Domo Chemical 1300 IF 102.3), and 5% (wt./wt.) of a maleated polyethylene (melt index of 8 g/10 min. and 1.4 wt. % of grafted maleic anhydride) were prepared using the procedure and conditions of Example 1.

35% (wt./wt.) of the resulting concentrate pellets and 65% (wt./wt.) of a linear low-density polyethylene resin (HIFOR® LT74104) were pellet blended and formed into a monolayer cast film using the procedure and conditions of Example 1, except film thickness was from 3 to 3.5 mils.

This film was then subjected to testing for packing film properties. The results are reported in Table 2 below.

TABLE 2

| | Ex. 6 | Ex. 7 |
|---|---|---|
| Concentrate | | |
| Comp. | | |
| (wt. %) | | |
| LLDPE | 65 | 65 |
| PA 6 | 30 | — |
| PA 6 | — | 30 |
| Nanocomposite | | |
| mal-PE | 5 | 5 |
| Film Comp. | | |
| (wt. %) | | |
| Concentrate | 35 | 35 |
| LLDPE | 65 | 65 |
| Film | 3.5 | 3.0 |
| Thickness | | |
| (mil) | | |
| Optical | | |
| Properties | | |
| Clarity (%) | 39.2 | 75.4 |
| Gloss at 45° | 6.6 | 26.5 |
| Haze (%) | 52.6 | 16.4 |
| Tensile | | |
| Strength (psi) | | |
| At Break MD | 4853 | 5523 |
| At Yield MD | 1285 | 1654 |
| Tensile | | |
| Toughness | | |
| (ft-lbs/in³) | | |
| MD | 2018 | 2394 |
| Elongation (%) | | |
| MD | 934 | 954 |
| Secant | | |
| Modulus (psi) | | |
| MD | 25900 | 33900 |
| Puncture | | |
| Resistance | | |
| Force per mil | 5.02 | 5.05 |
| (lbs/mil) | | |
| Load at Break | 17.56 | 17.67 |
| (lbs) | | |
| Energy to | 4.43 | 5.88 |
| Break | | |
| (in-lbs) | | |
| Penetration | 2.55 | 2.90 |
| (inches) | | |
| Elmendorf | | |
| Tear (g) | | |
| MD | 485 | 790 |

As seen in Table 2, the film containing the nylon nanocomposite and the maleated polyethylene compatibilizer (Example 7) had better optical (e.g., clarity, gloss, and/or haze) and mechanical properties (e.g., tensile strength, tensile toughness, elongation, Secant modulus, and/or Elmendorf tear) than the corresponding film without the nylon nanocomposite (Example 6).

These films (Examples 6 and 7) were not analyzed by optical microscopy.

### Example 8—Control

### Preparation of PE Film

100% (wt./wt.) of a linear low-density polyethylene (Westlake Chemical HIFOR® LF2020AA having a melt index of 1.0 g/10 min. and density of 0.919 g/cm³) was added to the feed of a monolayer casting film line and formed into a monolayer cast film. The extrusion barrel temperature set point was 163° C. in zone 1, 185° C. in zone 2, 204° C. in zone 3, 220° C. in the adapter zone, and 235° C. in the die zone. The screw speed was between 100 and 120 RPM. The melt pressure was between 2,600 and 3,200 psi. The melt temperature was between 240° C. and 243° C. The winder line speed was between 4 and 5 m/min, the nip tension was set at 7 Nm, and the winder tension was set at 6 Nm. Film width was targeted at 6.5-7.0 inches using an 8-inch sheet die, and film thickness ranged from 2.1 to 2.4 mils. The chill-roll temperature was set at 20° C. The output of the process was 6 lbs/hr.

This film was then subjected to testing for packing film properties. The results are reported in Table 3 below.

### Example 9—Comparative

### Preparation of PE Film Containing Nylon, EVOH, and Compatibilizer (RETAIN®)

55% (wt./wt.) of a linear low-density polyethylene (Westlake Chemical HIFOR® LF2020AA having a melt index of 1.0 g/10 min. and density of 0.919 g/cm³), 30% (wt./wt.) of a polyamide 6 without nanoparticles (BASF B40), 10% (wt./wt.) of an ethylene-vinyl alcohol copolymer (Kuraray EVAL F171B), and 5% (wt./wt.) of a maleated polyethylene copolymer compatibilizer (Dow RETAIN® 3000 having a melt index of 660 g/10 min. and density of 0.870 g/cm³ and containing 1.4 wt % of grafted maleic anhydride) were added in pellet form to a 40-mm twin-screw extruder and melt blended to form a concentrate. The extrusion barrel temperature set point was 245° C. in zones 2 through 12, and 245° C. at the die. The screw speed was 250 RPM (revolutions per minute) with a 25 SCFH (Standard Cubic Foot per Hour) nitrogen purge rate and a total output of 80 pounds per hour. The melt blend concentrate was pelletized for further processing.

35% (wt./wt.) of the resulting concentrate pellets and 65% (wt./wt.) of the linear low-density polyethylene resin (HIFOR® LF2020AA) were added to the feed of a monolayer casting film line as a pellet blend and formed into a monolayer cast film using the procedure and conditions of Example 8.

This film was then subjected to testing for packing film properties. The results are reported in Table 3 below.

### Example 10—Inventive

### Preparation of PE Film Containing Nanocomposite, EVOH, and Compatibilizer (RETAIN®)

Pellets of a concentrate containing 55% (wt./wt.) of a linear low-density polyethylene (Westlake Chemical HIFOR® LF2020AA having a melt index of 1.0 g/10 min. and density of 0.919 g/cm³), 30% (wt./wt.) of a polyamide 6 nanocomposite (Domo Chemical 1300 IF 102.3), 10% (wt./wt.) of an ethylene-vinyl alcohol copolymer (Kuraray EVAL F171B), and 5% (wt./wt.) of a maleated polyethylene copolymer compatibilizer (Dow RETAIN® 3000) were prepared using the procedure and conditions of Example 9.

35% (wt./wt.) of the resulting concentrate pellets and 65% (wt./wt.) of the linear low-density polyethylene resin (HIFOR® LF2020AA) were added to the feed of a monolayer casting film line as a pellet blend and formed into a monolayer cast film using the procedure and conditions of Example 8.

This film was then subjected to testing for packing film properties. The results are reported in Table 3 below.

### Example 11—Comparative

### Preparation of PE Film Containing Nylon, EVOH, and Compatibilizer (Mal-EMAC®)

Pellets of a concentrate containing 55% (wt./wt.) of a linear low-density polyethylene (Westlake Chemical HIFOR® LF2020AA having a melt index of 1.0 g/10 min. and density of 0.919 g/cm³), 30% (wt./wt.) of a polyamide 6 without nanoparticles (BASF B40), 10% (wt./wt.) of an ethylene-vinyl alcohol copolymer (Kuraray EVAL F171B), and 5% (wt./wt.) of a maleated ethylene-methyl acrylate copolymer compatibilizer (melt index of 600 g/10 min., 24 wt % methyl acrylate, and 1.4 wt % of grafted maleic anhydride) were prepared using the procedure and conditions of Example 9.

35% (wt./wt.) of the resulting concentrate pellets and 65% (wt./wt.) of the linear low-density polyethylene resin (HIFOR® LF2020AA) were added to the feed of a monolayer casting film line as a pellet blend and formed into a monolayer cast film using the procedure and conditions of Example 8.

This film was then subjected to testing for packing film properties. The results are reported in Table 3 below.

### Example 12—Inventive

### Preparation of PE Film Containing Nanocomposite, EVOH, and Compatibilizer (Mal-EMAC®

Pellets of a concentrate containing 55% (wt./wt.) of a linear low-density polyethylene (Westlake Chemical HIFOR® LF2020AA having a melt index of 1.0 g/10 min. and density of 0.919 g/cm³), 30% (wt./wt.) of a polyamide 6 nanocomposite (Domo Chemical 1300 IF 102.3), 10% (wt./wt.) of an ethylene-vinyl alcohol copolymer (Kuraray EVAL F171B), and 5% (wt./wt.) of a maleated ethylene-methyl acrylate copolymer compatibilizer (melt index of 600 g/10 min., 24 wt % methyl acrylate, and 1.4 wt % of grafted maleic anhydride) were prepared using the procedure and conditions of Example 9.

35% (wt./wt.) of the resulting concentrate pellets and 65% (wt./wt.) of the linear low-density polyethylene resin (HIFOR® LF2020AA) were added to the feed of a monolayer casting film line as a pellet blend and formed into a monolayer cast film using the procedure and conditions of Example 8.

This film was then subjected to testing for packing film properties. The results are reported in Table 3 below.

TABLE 3

| | Ex. 8 | Ex. 9 | Ex. 10 | Ex. 11 | Ex. 12 |
|---|---|---|---|---|---|
| Concentrate | | | | | |
| Comp. | | | | | |
| (wt %) | | | | | |
| LLDPE | — | 55 | 55 | 55 | 55 |
| PA 6 | | 30 | 0 | 30 | 0 |
| PA 6 | — | 0 | 30 | 0 | 30 |
| Nano- | | | | | |
| composite | | | | | |
| EVOH | | 10 | 10 | 10 | 10 |
| mal-PE | — | 5 | 5 | 0 | 0 |
| mal- | — | 0 | 0 | 5 | 5 |
| EMAC ® | | | | | |
| Film Comp. | | | | | |
| (wt. %) | | | | | |
| Concentrate | — | 35 | 35 | 35 | 35 |
| LLDPE | 100 | 65 | 65 | 65 | 65 |
| Film | 2.4 | 2.2 | 2.1 | 2.3 | 2.4 |
| Thickness | | | | | |
| (mil) | | | | | |
| Optical | | | | | |
| Properties | | | | | |
| Clarity (%) | 99.1 | 8.4 | 21.2 | 9.5 | 20.0 |
| Gloss at 45° | 21.5 | 6.1 | 7.0 | 6.0 | 10.6 |
| Haze (%) | 2.1 | 82.5 | 58.2 | 80.5 | 56.7 |
| Tensile | | | | | |
| Strength | | | | | |
| (psi) | | | | | |
| At Break | 4827 | 4902 | 6371 | 5093 | 6025 |
| MD | | | | | |
| At Yield | 1129 | 1499 | 1683 | 1490 | 1596 |
| MD | | | | | |
| Tensile | | | | | |
| Toughness | | | | | |
| (ft-lbs/in³) | | | | | |
| MD | 1868 | 2359 | 3238 | 2404 | 2876 |
| Elongation | | | | | |
| (%) | | | | | |
| MD | 858 | 1023 | 1065 | 1015 | 1018 |
| Secant | | | | | |
| Modulus | | | | | |
| (psi) | | | | | |
| MD | 14000 | 22500 | 39500 | 22900 | 37600 |
| Puncture | | | | | |
| Resistance | | | | | |
| Force per | 6.70 | 4.67 | 3.27 | 4.89 | 5.14 |
| mil (lbs/mil) | | | | | |
| Load at | 16.08 | 10.27 | 6.88 | 11.25 | 12.33 |
| Break (lbs) | | | | | |
| Energy to | 7.04 | 1.72 | 3.43 | 2.23 | 3.24 |
| Break | | | | | |
| (in-lbs) | | | | | |
| Penetration | 5.02 | 2.75 | 2.92 | 2.61 | 2.70 |
| (inches) | | | | | |
| Elmendorf | | | | | |
| Tear (g) | | | | | |
| MD | 680 | 663 | 660 | 636 | 708 |

As seen in Table 3, in compositions with EVOH present, the film containing the nylon nanocomposite and the RETAIN® compatibilizer (Example 10) had better optical and mechanical properties (e.g., tensile strength, tensile toughness, elongation, Secant modulus, puncture resistance, and Elmendorf tear) than the corresponding film without the nylon nanocomposite (Example 9). The film containing the nylon nanocomposite and the mal-EMAC® compatibilizer (Example 12) had better optical (e.g., clarity, gloss, and haze) and mechanical properties (e.g., tensile strength, tensile toughness, elongation, Secant modulus, puncture resistance, and Elmendorf tear) than the corresponding film without the nylon nanocomposite (Example 11). The cast film containing the mal-EMAC® compatibilizer (Examples 11 and 12) had comparable optical properties and mechanical properties to the corresponding film with the RETAIN® compatibilizer (Examples 9 and 10), both with and without the nylon nanocomposite.

The films from Examples 9-12 were also analyzed by optical microscopy using the procedure and conditions of Examples 2-5 (unless otherwise noted).

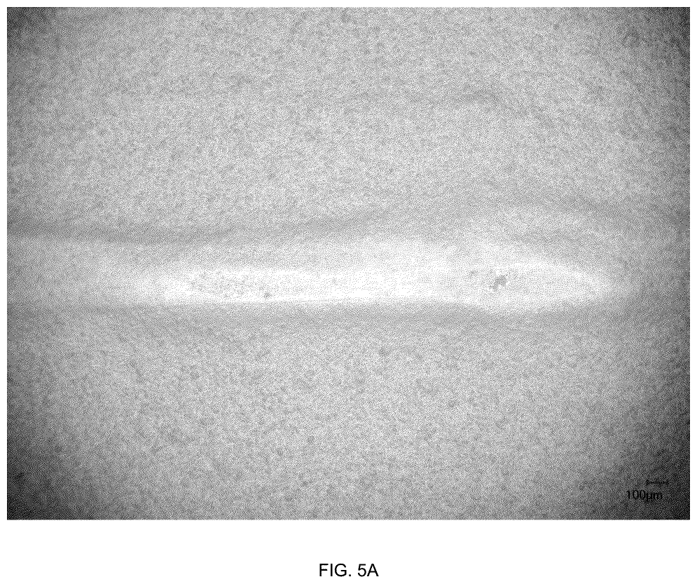

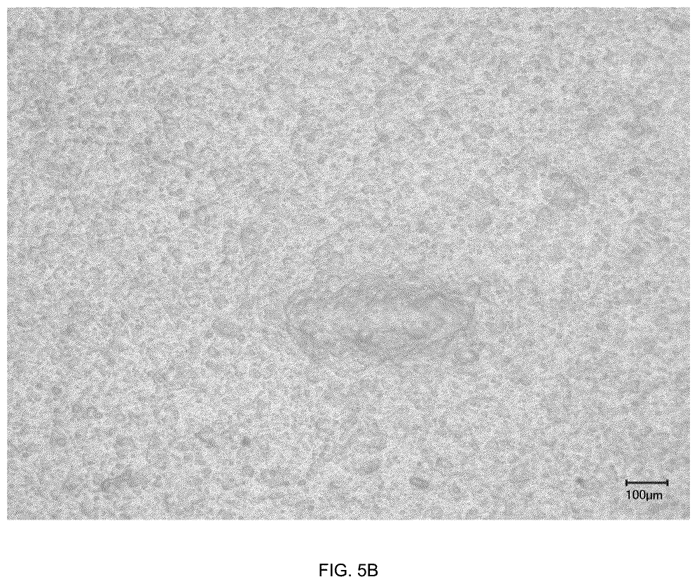

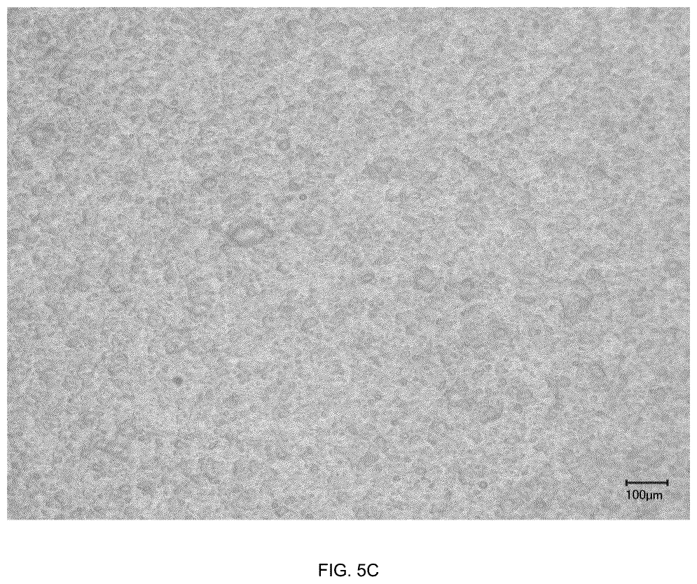

Three representative micrographs are shown for each composition in FIGS. 5-8, respectively. All micrographs were captured at a magnification of 200×, except for FIG. 5A, which was captured at 100×.

As seen in FIGS. 5A-5C (nylon, EVOH, and RETAIN® compatibilizer (Example 9)), the microscopic images show no detectable voids, but huge unmelts, a significant number of huge gels, and poor miscibility.

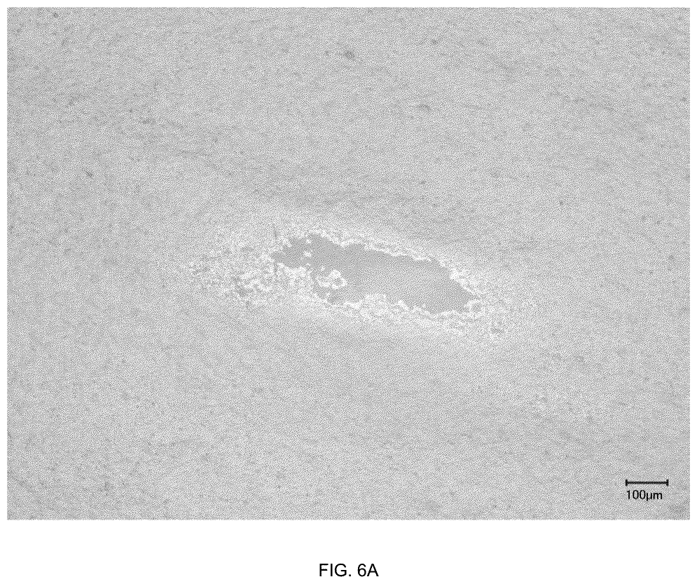

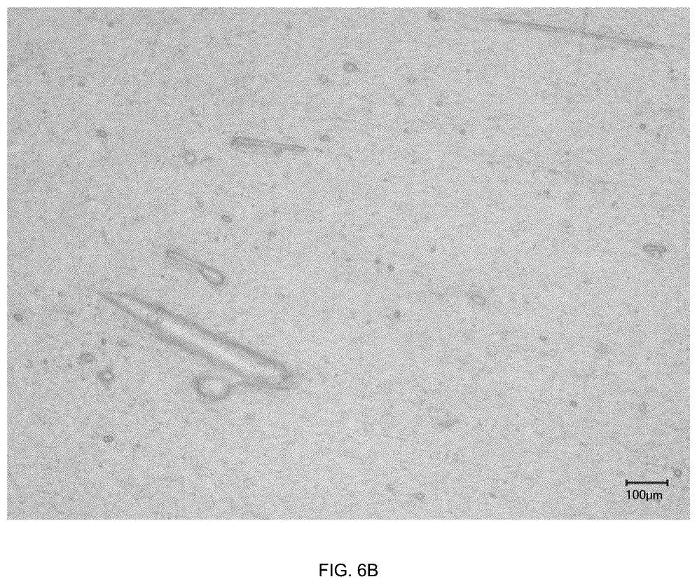

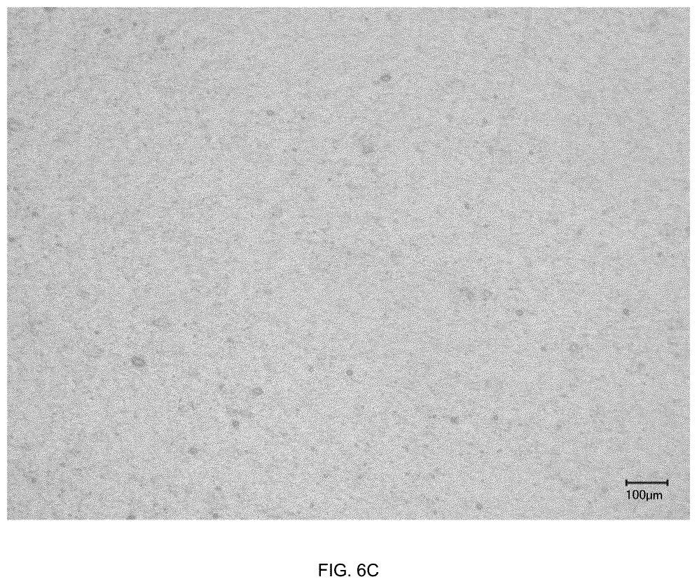

As seen in FIGS. 6A-6C (nanocomposite, EVOH, and RETAIN® compatibilizer (Example 10)), the microscopic images show no detectable voids, but huge unmelts, a small number of big gels, and average miscibility.

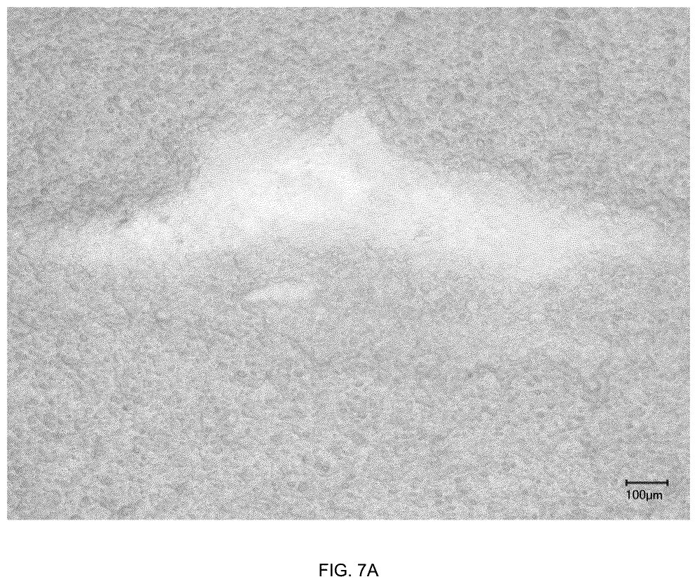

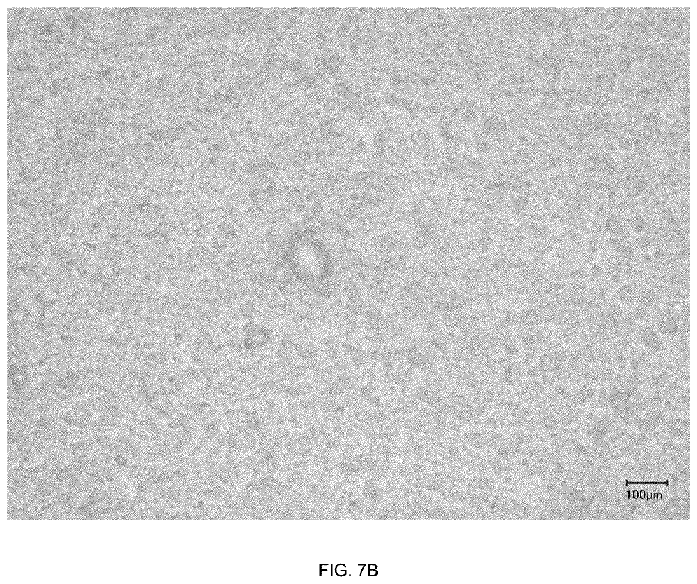

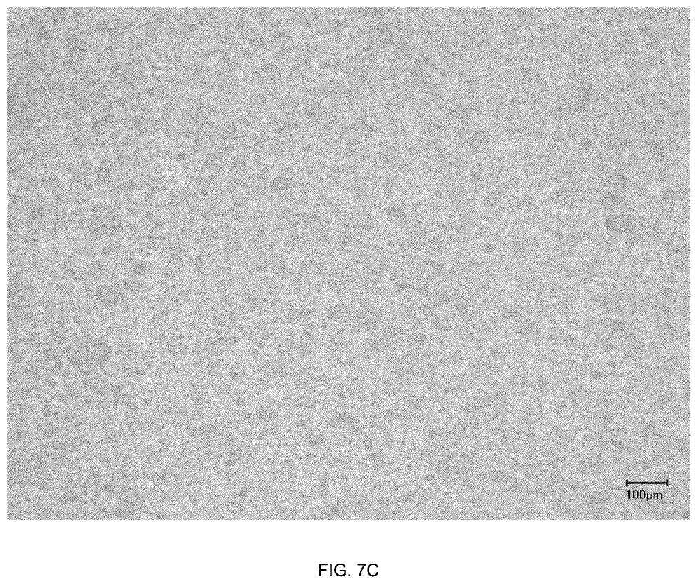

As seen in FIGS. 7A-7C (nylon, EVOH, and mal-EMAC® compatibilizer (Example 11)), the microscopic images show no detectable voids, but huge unmelts, a considerable number of gels, and poor miscibility.

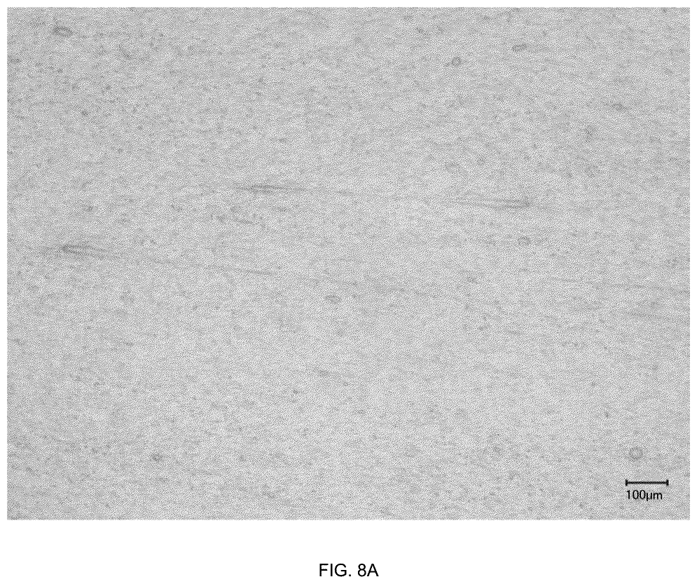

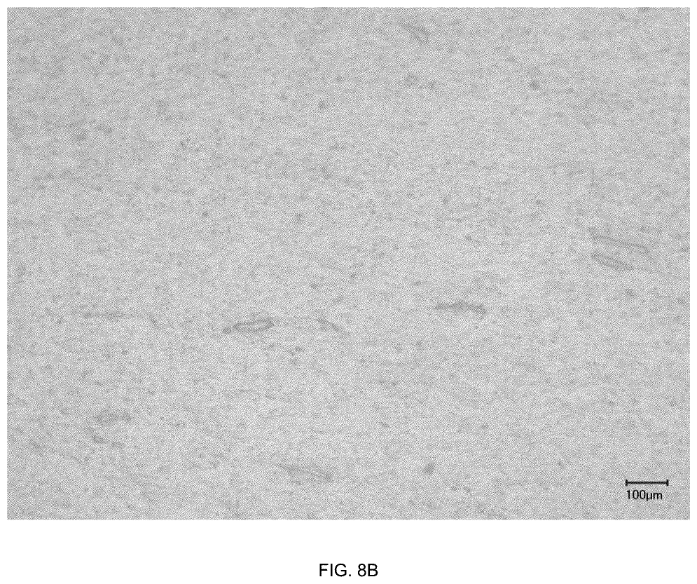

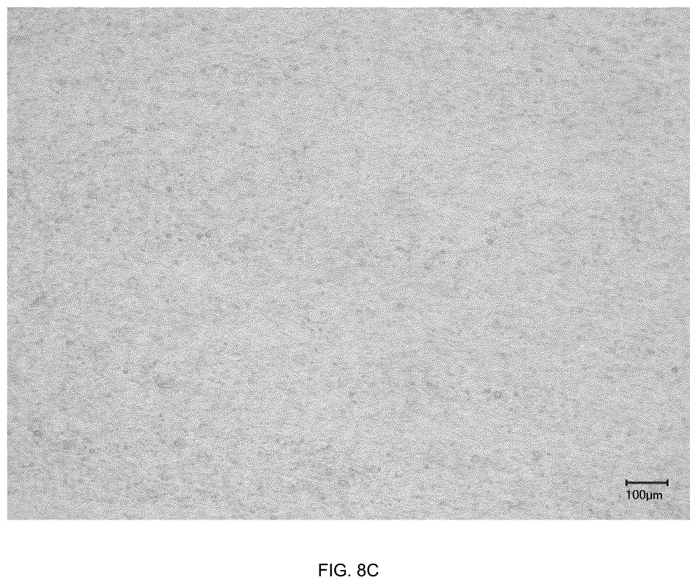

As seen in FIGS. 8A-8C (nanocomposite, EVOH, and mal-EMAC® compatibilizer (Example 12)), the microscopic images show long thin stretched out gels, but no detectable voids and good miscibility.

Among the films containing EVOH (Examples 9-12), the film with the nanocomposite and the mal-EMAC® compatibilizer (Example 12) appeared the best, followed by the film with the nanocomposite and the RETAIN® compatibilizer (Example 10), then the film with the nylon and the mal-EMAC® compatibilizer (Example 11), and then the film with the nylon and the RETAIN® compatibilizer (Example 9).

The invention has been described in detail with particular reference to preferred embodiments thereof, but it will be understood that variations and modifications can be made within the spirit and scope of the invention.

We claim:

1. A cast film made from a composition comprising:
(a) an ungrafted ethylene-based polymer;
(b) a nanocomposite comprising a polyamide and montmorillonite; and
(c) a compatibilizer comprising a maleic anhydride grafted ethylene-based polymer.

2. The cast film of claim 1, wherein the ungrafted ethylene-based polymer comprises high-density polyethylene (HDPE), low-density polyethylene (LDPE), linear low-density polyethylene (LLDPE), very-low-density polyethylene (VLDPE), ultra-low-density polyethylene (ULDPE), or combinations thereof.

3. The cast film of claim 1, wherein the ungrafted ethylene-based polymer has a melt index of 0.1 to 50 g/10 min.

4. The cast film of claim 1, wherein the ungrafted ethylene-based polymer comprises LLDPE.

5. The cast film of claim 1, wherein the polyamide comprises nylon 4.6, nylon 6, nylon 6.6, nylon 6.10, nylon 6.12, nylon 11, nylon 12, amorphous nylon, or combinations thereof.

6. The cast film of claim 1, wherein the polyamide comprises nylon 6.

7. The cast film of claim 1, wherein the compatibilizer comprises a maleic anhydride grafted HDPE, a maleic anhydride grafted LDPE, a maleic anhydride grafted LLDPE, a maleic anhydride grafted VLDPE, a maleic anhydride grafted ULDPE, a maleic anhydride grafted ethylene-(meth)acrylate copolymer, a maleic anhydride grafted ethylene-alkyl (meth)acrylate copolymer, a maleic anhydride grafted ethylene-vinyl acetate copolymer, or combinations thereof.

8. The cast film of claim 1, wherein the compatibilizer comprises a maleic anhydride grafted ULDPE.

9. The cast film of claim 1, wherein the compatibilizer comprises a maleic anhydride grafted ethylene-methyl acrylate copolymer or a maleic anhydride grafted ethylene-butyl acrylate copolymer.

10. The cast film of claim 1, wherein the compatibilizer has a melt index of 1 to 1,000 g/10 min.

11. The cast film of claim 1, wherein the composition comprises 70 to 99 wt % of the ungrafted ethylene-based polymer.

12. The cast film of claim 1, wherein the composition comprises 1 to 40 wt % of the nanocomposite.

13. The cast film of claim 1, wherein the composition comprises 0.1 to 15 wt % of the compatibilizer.

14. The cast film of claim 1, which further comprises an ethylene-vinyl alcohol copolymer.

15. A method of making the cast film of claim 1, the method comprising:
(a) extruding a polymeric melt through a flat die to form a sheet of polymer;
(b) passing the sheet on to a chill roll; and
(c) cooling the sheet to obtain the cast film.

16. An extrusion-coated substrate comprising:
(a) a film made from a composition comprising:
(i) an ungrafted ethylene-based polymer;
(ii) a nanocomposite comprising a polyamide and montmorillonite; and
(iii) a compatibilizer comprising a maleic anhydride grafted ethylene-based polymer, and
(b) a flexible substrate coated with the film.

17. The extrusion-coated substrate of claim 16, wherein the ungrafted ethylene-based polymer comprises high-density polyethylene (HDPE), low-density polyethylene (LDPE), linear low-density polyethylene (LLDPE), very-low-density polyethylene (VLDPE), ultra-low-density polyethylene (ULDPE), or combinations thereof.

18. The extrusion-coated substrate of claim 16, wherein the ungrafted ethylene-based polymer has a melt index of 0.1 to 50 g/10 min.

19. The extrusion-coated substrate of claim 16, wherein the ungrafted ethylene-based polymer comprises LLDPE.

20. The extrusion-coated substrate of claim 16, wherein the polyamide comprises nylon 4.6, nylon 6, nylon 6.6, nylon 6.10, nylon 6.12, nylon 11, nylon 12, amorphous nylon, or combinations thereof.

21. The extrusion-coated substrate of claim 16, wherein the polyamide comprises nylon 6.

22. The extrusion-coated substrate of claim 16, wherein the compatibilizer comprises a maleic anhydride grafted HDPE, a maleic anhydride grafted LDPE, a maleic anhydride grafted LLDPE, a maleic anhydride grafted VLDPE, a maleic anhydride grafted ULDPE, a maleic anhydride grafted ethylene-(meth)acrylate copolymer, a maleic anhydride grafted ethylene-alkyl (meth)acrylate copolymer, a maleic anhydride grafted ethylene-vinyl acetate copolymer, or combinations thereof.

23. The extrusion-coated substrate of claim 16, wherein the compatibilizer comprises a maleic anhydride grafted ULDPE.

24. The extrusion-coated substrate of claim 16, wherein the compatibilizer comprises a maleic anhydride grafted ethylene-methyl acrylate copolymer or a maleic anhydride grafted ethylene-butyl acrylate copolymer.

25. The extrusion-coated substrate of claim 16, wherein the compatibilizer has a melt index of 1 to 1,000 g/10 min.

26. The extrusion-coated substrate of claim 16, wherein the composition comprises 70 to 99 wt % of the ungrafted ethylene-based polymer.

27. The extrusion-coated substrate of claim 16, wherein the composition comprises 1 to 40 wt % of the nanocomposite.

28. The extrusion-coated substrate of claim 16, wherein the composition comprises 0.1 to 15 wt % of the compatibilizer.

29. The extrusion-coated substrate of claim 16, wherein the composition further comprises an ethylene-vinyl alcohol copolymer.

30. The extrusion-coated substrate of claim 16, wherein the flexible substrate comprises paper, paperboard, metal foil, nonwoven fabric, plastic film, or combinations thereof.

31. A method of making the extrusion-coated substrate of claim 16, the method comprising:
(a) extruding a polymeric melt through a flat die to form a sheet of polymer;
(b) contacting the sheet with a moving flexible substrate;
(c) pressing the sheet and the substrate together between a pressure roll and a chill roll; and
(d) cooling the pressed sheet and substrate to obtain the extrusion-coated substrate.
